(19) United States
(12) Patent Application Publication
(10) Pub. No.: US 2016/0198061 A1
(43) Pub. Date: Jul. 7, 2016

(54) Image Forming Apparatus, Image Forming Method, and Recording Medium That Prevent Missing of Information in Performing Reduced Printing of Image Data

(71) Applicant: Kyocera Document Solutions Inc., Osaka (JP)

(72) Inventor: Shogo Yoneda, Osaka (JP)

(21) Appl. No.: 14/990,726

(22) Filed: Jan. 7, 2016

(30) Foreign Application Priority Data
Jan. 7, 2015 (JP) 2015-001331

(51) Int. Cl. H04N 1/04; H04N 1/23; B41J 29/38; H04N 1/00

(52) U.S. Cl. CPC H04N 1/0432; H04N 1/0032; H04N 1/00411; H04N 1/00822; H04N 1/2369; B41J 29/38; H04N 2201/0094

(57) ABSTRACT

An image forming apparatus includes an equal-magnification-region-designation accepting circuit, a front-surface-image generating circuit, a back-surface-image generating circuit, and a duplex printing circuit. The front-surface-image generating circuit reduces the image in accordance with the reduction magnification to generate image data representing the reduced image as image data representing a front-surface-side image of duplex printing. The back-surface-image generating circuit uses the designated equal-magnification region in the image before the reduction by a magnification equal to the magnification of the image to generate image data representing a back-surface-side image of duplex printing. The duplex printing circuit prints an image corresponding to the front-surface-side image data on a front surface of a predetermined paper sheet and an image corresponding to the back-surface-side image data on the back surface of the paper sheet.

### INCORPORATION BY REFERENCE

This application is based upon, and claims the benefit of priority from, corresponding Japanese Patent Application No. 2015-001331 filed in the Japan Patent Office on Jan. 7, 2015, the entire contents of which are incorporated herein by reference.

### BACKGROUND

Unless otherwise indicated herein, the description in this section is not prior art to the claims in this application and is not admitted to be prior art by inclusion in this section.

A recent image forming apparatus, such as a copier and a multi-functional peripheral, includes versatile functions such as a facsimile transmission function, a scan function, a print function, and an automatic document feeding and reading function. Due to a recent trend of resource savings, approximately all these functions use a reduced-printing function that prints image data by reducing the image data. Thus, a usage frequency of the reduced-printing function is high.

Especially, in recent years, demand for an A4-type image forming apparatus, which prints on A4-size paper sheets, has been increasing. Thus, such A4-type image forming apparatus is required to have an equivalent usage pattern to an A3-type image forming apparatus, which handles an A3-size paper sheet having twice the size of an A4-size paper sheet.

However, when a user performs a reduced-printing function to A3-size image data with an A4-type image forming apparatus as follows: specifically, a user may cause the A3-size image data to be reduced to A4-size image data, and then cause this reduced A4-size image data to form the image on an A4-size paper sheet. In this case, the characters included in the A3-size image data are consequently reduced, and this degrades visibility. Thus, this causes a problem that an A4-type image forming apparatus has difficulty in achieving an equivalent usage pattern to an A3-type image forming apparatus.

For example, there is proposed a technique that enlarges and reduces image data by an aspect corresponding to user's demand. This technique partially performs equal magnification of a range selected by a user and outputs. Even when a reduced-printing function is applied to image data with, for example, barcode, this technique can output this barcode without problems.

### SUMMARY

An image forming apparatus according to one aspect of the disclosure includes an equal-magnification-region-designation accepting circuit, a front-surface-image generating circuit, a back-surface-image generating circuit, and a duplex printing circuit. The equal-magnification-region-designation accepting circuit accepts a reduction magnification of a reduced printing and a designation of an equal-magnification region in the reduced printing that prints a reduced image represented by image data. The equal-magnification region is a target of an equal-magnification printing in the image. The front-surface-image generating circuit reduces the image in accordance with the reduction magnification to generate image data representing the reduced image as image data representing a front-surface-side image of duplex printing. The back-surface-image generating circuit uses the designated equal-magnification region in the image before the reduction by a magnification equal to the magnification of the image to generate image data representing a back-surface-side image of duplex printing. The duplex printing circuit prints an image corresponding to the front-surface-side image data on a front surface of a predetermined paper sheet and an image corresponding to the back-surface-side image data on the back surface of the paper sheet.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 conceptually illustrates an overall configuration of an inside of an image forming apparatus according to an embodiment of the disclosure.

FIG. 2 illustrates an image forming apparatus according to one embodiment.

FIG. 3 illustrates an execution procedure according to the one embodiment.

FIG. 4A illustrates an exemplary reduced-printing screen according to the one embodiment.

FIG. 4B illustrates one example of generation of front-surface-side and back-surface-side image data according to the one embodiment.

FIG. 5A illustrates one example of two equal-magnification regions according to the one embodiment.

FIG. 5B illustrates one example that adds numbers to each of the two equal-magnification regions according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes embodiments of an image forming apparatus and an image forming method according to the disclosure by referring to the attached drawings, for ease of understanding the disclosure. Please note that the following embodiments are merely exemplary embodiments according to the disclosure and not intended to limit the technical scope of the disclosure. The letter “S” attached before numerals in the flowchart mean steps.

The following describes an image forming apparatus as one example of the embodiments of the disclosure. The image forming apparatus of the disclosure corresponds to, for example, a multi-functional peripheral (MFP) including functions such as a facsimile, a copier, a scanner, and a printer.

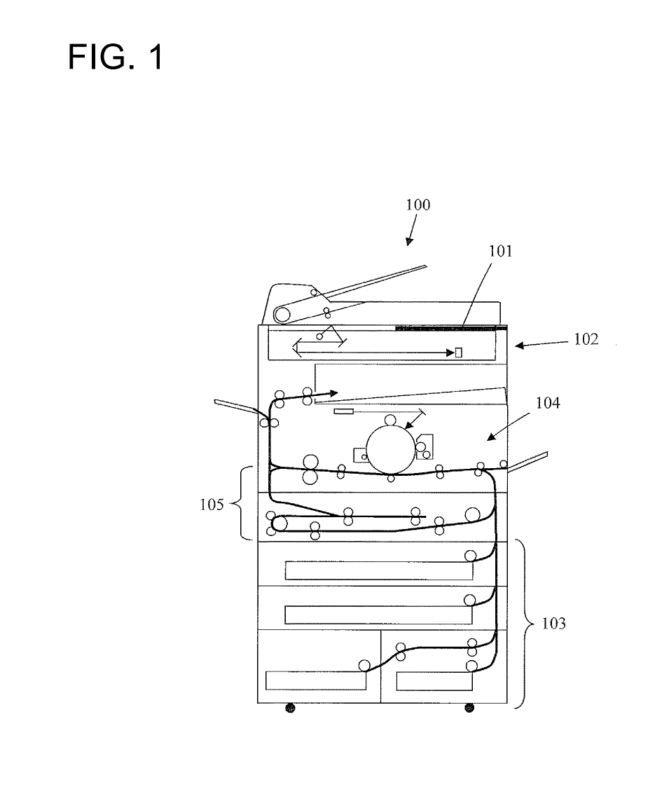

As illustrated in FIG. 1, a multi-functional peripheral 100 accepts a setting condition of a print job from a user via an operation unit 101 and provides this print job by driving respective units such as an image reading unit 102, a conveyance path 103, and an image forming unit 104. The operation unit 101 includes a touch panel and ensures instruction inputs from a user or a screen display. The image reading unit 102 reads a document placed on a platen or an image of a document placed in an automatic document feeding unit. Further, the conveyance path 103 conveys paper sheets from a sheet feed cassette or a manual bypass tray, in which the paper sheets are preliminarily placed, in accordance with the setting condition. The image forming unit 104 performs image formation by transferring a toner image, which corresponds to image data, on the conveyed paper sheet and then fixing the toner image with a fixing roller. The image-formed paper sheet is a single-side printed matter where only single-side is printed.

Here, the conveyance path 103 conveys the printed single-side printed matter to a sheet discharge tray or to a duplex printing conveyance path 105 for performing duplex printing. The duplex printing conveyance path 105 turns over the conveyed single-side printed matter, and conveys this turned-over single-side printed matter to a part of the conveyance path 103 located forward with respect to the image forming unit 104. This ensures generation of a duplex printed matter by the image forming unit 104 transferring a toner image, which corresponds to image data, onto the turned-over single-side printed matter and then fixing the toner image with the fixing roller. The duplex printed matter is conveyed to the sheet discharge tray via the conveyance path 103.

The control circuit (not illustrated) of the multi-functional peripheral 100 connects a central processing unit (CPU), a read only memory (ROM), a random access memory (RAM), a hard disk drive (HDD), and drivers corresponding to respective driving units via an internal bus.

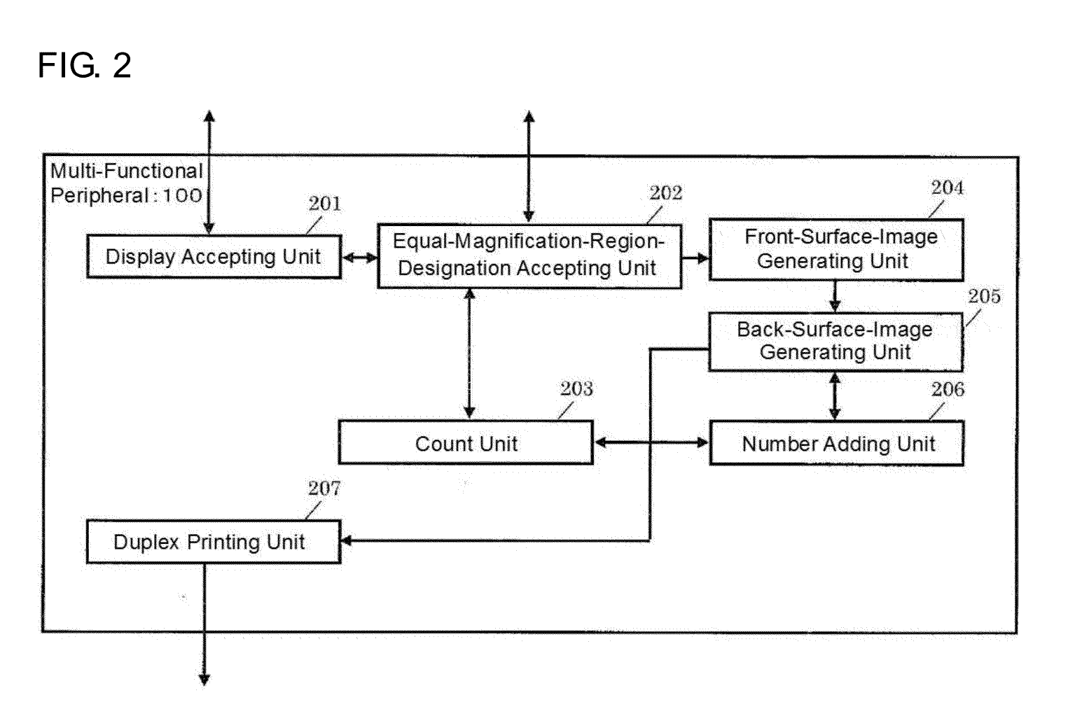

The CPU of the multi-functional peripheral 100 executes programs stored in the ROM, HDD, and similar memory, for example, by using the RAM as a work area. The CPU transmits and receives data, instructions, signals, commands, and similar information from the drivers based on this execution result, and thus controls operations of the respective driving units relating to the execution of the print job. Similarly for respective units (illustrated in FIG. 2), which will be described later, other than the driving units, the CPU achieves these respective units by executing respective programs. The ROM, RAM, HDD, and similar memory store programs and data for achieving the respective units described below.

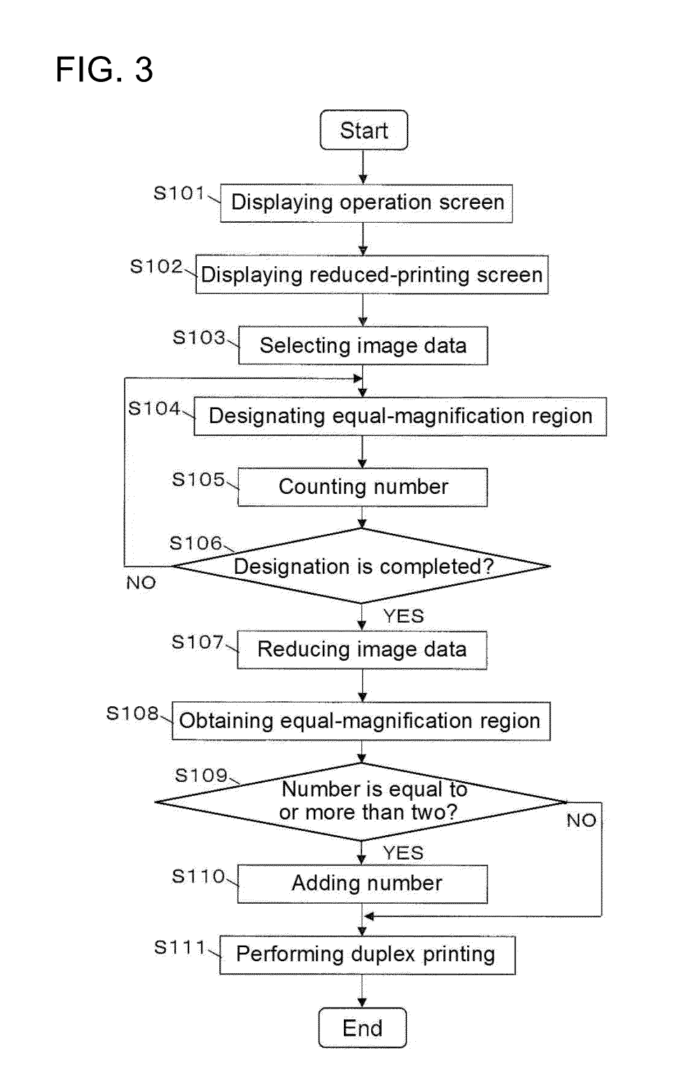

Next, by referring to FIGS. 2 and 3, a description will be given of the configuration and the execution procedure according to the embodiment of the disclosure. First, turning on a power supply of the multi-functional peripheral 100 by a user activates this multi-functional peripheral 100, and a display accepting unit 201 displays an operation screen on the touch panel of the operation unit 101 (FIG. 3: S101).

Here, when the user selects a reduced-printing-mode key displayed in the operation screen in executing reduced printing of image data, the display accepting unit 201 accepts the selection of this reduced-printing-mode key and notifies an equal-magnification-region-designation accepting unit 202 (also referred to as an equal-magnification-region-designation accepting circuit) of the acceptance. This notified equal-magnification-region-designation accepting unit 202 causes a mode to move from a normal mode to a reduced-printing mode, and displays a reduced-printing screen 400 corresponding to the reduced-printing-mode key on the touch panel (FIG. 3: S102).

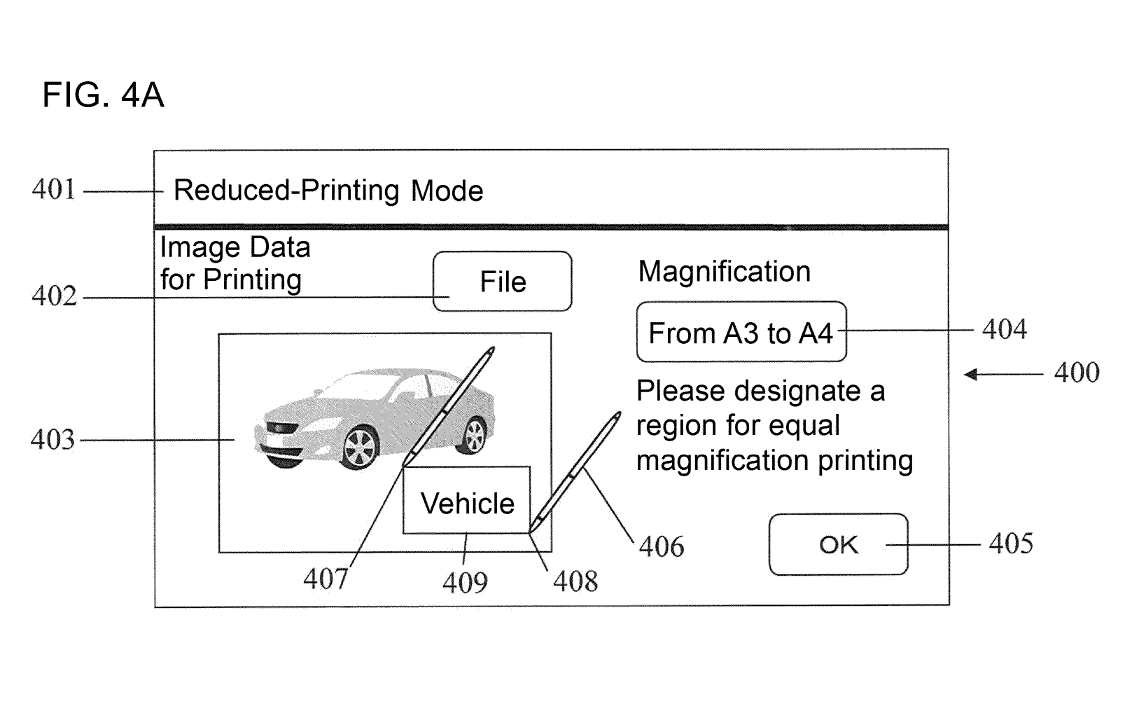

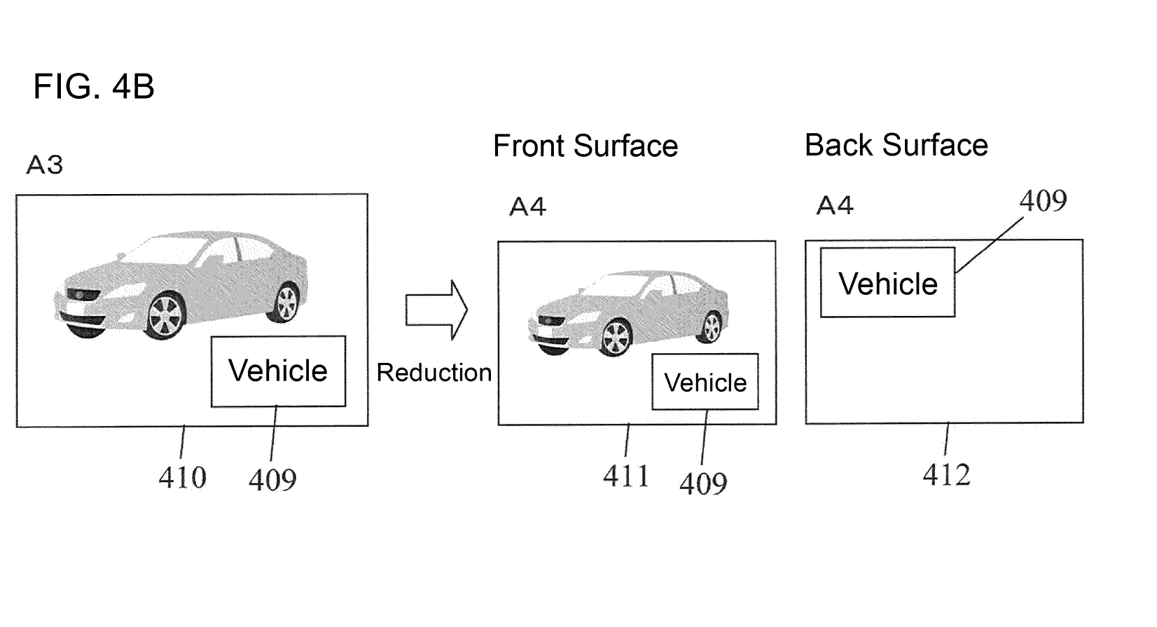

The reduced-printing screen 400, as illustrated in FIG. 4A, displays the following: a message 401 indicating the reduced-printing mode; a file key 402 for selecting image data for reduced printing; a preview image display field 403 for displaying a preview image of the image data for the reduced printing; a reduction magnification key 404 for selecting magnification of the reduced printing; and an OK key 405.

Then, the equal-magnification-region-designation accepting unit 202 accepts the selection of the image data for the reduced printing from the user (FIG. 3: S103).

Here, the method with which the equal-magnification-region-designation accepting unit 202 accepts the selection of the image data is not especially limited. For example, when the file key 402 is selected, the equal-magnification-region-designation accepting unit 202 selectably displays a plurality of image data stored in a predetermined memory for the user, and then accepts the selection of the specific image data from the user. Here, when the user selects the specific image data, the equal-magnification-region-designation accepting unit 202 causes an image represented by this selected image data to be displayed in the preview image display field 403.

The method with which the equal-magnification-region-designation accepting unit 202 accepts the selection of the reduction magnification is not especially limited. For example, when the reduction magnification key 404 is selected, the equal-magnification-region-designation accepting unit 202 selectably displays a plurality of reduction-magnification-candidate keys for the user. Here, the reduction-magnification-candidate key can include, for example, a “reduction from A3 to A4” key, which reduces a paper sheet from an A3-size paper sheet to an A4-size paper sheet, a “reduction from B3 to A4” key, which reduces a paper sheet from a B3-size paper sheet to an A4-size paper sheet, and similar key. If the multi-functional peripheral 100 is an A4-type image forming apparatus, the paper sheet size for the reduced printing of the reduction-magnification-candidate key is set to an A4 size. Then, the equal-magnification-region-designation accepting unit 202 accepts the selection of the predetermined reduction-magnification-candidate key from the user. Here, when the user selects the “reduction from A3 to A4” key, the equal-magnification-region-designation accepting unit 202 causes this selected “reduction from A3 to A4” key to be displayed in the reduction magnification key 404.

Then the equal-magnification-region-designation accepting unit 202 accepts designation of an equal-magnification region, which is a target of equal-magnification printing, among the displayed image from the user (FIG. 3: S104).

Here, the method with which the equal-magnification-region-designation accepting unit 202 accepts the designation of the equal-magnification region is not especially limited. For example, the equal-magnification-region-designation accepting unit 202 accepts the designation of two specified points 407 and 408 by a stylus pen 406 or user's finger, in the image displayed in the preview image display field 403. The equal-magnification-region-designation accepting unit 202 accepts a rectangular shape 409 (a frame), where a line segment connecting these two specified points 407 and 408 is its diagonal line, as the equal-magnification region. Such accepted equal-magnification region is temporarily stored in, for example, a predetermined memory. The equal-magnification region is not limited to the rectangular shape 409. The equal-magnification-region-designation accepting unit 202 may accept a polygonal equal-magnification region by accepting designation of a plurality of points. The rectangular shape 409 is also referred to as an equal-magnification region 409.

Here, when the user designates a region (such as “vehicle”) of characters included in this image as the equal-magnification region while viewing the image represented by the image data in the preview image display field 403, the equal-magnification-region-designation accepting unit 202 accepts the designation of this equal-magnification region, and notifies a count unit 203 (which is also referred to as a count circuit) of the designation. This notified count unit 203 counts the number of (or a count of) the designated equal-magnification region (FIG. 3: S105).

Here, the method with which the count unit 203 counts is not especially limited. For example, when an equal-magnification region is firstly designated, the count unit 203 adds “one time” to a predetermined initial value (“zero times”), and set this added value “one time” as the number of the designated equal-magnification region. Then, the count unit 203 temporarily holds the number of the designated equal-magnification region in a predetermined memory.

Next, after designating one equal-magnification region, when the user does not designate a region other than this equal-magnification region and selects the OK key 405 while viewing the reduced-printing screen 400, the equal-magnification-region-designation accepting unit 202 determines that designation of the equal-magnification region is completed (FIG. 3: YES in S106), and notifies a front-surface-image generating unit 204 (which is also referred to as a front-surface-image generating circuit) of the completion. This notified front-surface-image generating unit 204 reduces an image represented by the image data in accordance with a reduction magnification (“reduction from A3 to A4”, for example, “71%”), which is selected by the above-described method, and generates image data representing this reduced image as front-surface-side image data of duplex printing (FIG. 3: S107).

Here, the method with which the front-surface-image generating unit 204 generates the front-surface image data is not especially limited. For example, as illustrated in FIG. 4B, the front-surface-image generating unit 204 directly reduces the selected image 410, which is selected by the above-described method, in accordance with the reduction magnification. An image 411 representing this reduced image is used as the front-surface-side image 411 of duplex printing.

Here, reducing directly the image 410 reduces directly the equal-magnification region 409 inside this image 410. If the character (“vehicle”) is included in the equal-magnification region 409, the character is also reduced, and this degrades visibility relative to the user.

Thus, when generating the front-surface-side image data of the duplex printing, the front-surface-image generating unit 204 notifies a back-surface-image generating unit 205 (also referred to as a back-surface image generating circuit) of the generation. This notified back-surface-image generating unit 205 generates back-surface-side image data of the duplex printing using the designated equal-magnification region, among the selected image data before reduction, by a magnification identical to the magnification of this image data (FIG. 3: S108).

Here, the method with which the back-surface-image generating unit 205 generates the back-surface-side image data is not especially limited. For example, as illustrated in FIG. 4B, the back-surface-image generating unit 205 obtains the designated equal-magnification region 409 in unchanged magnification (“100%”) from the selected image 410 or obtains the equal-magnification region 409 temporarily stored in the memory. Then, the back-surface-image generating unit 205 locates this obtained equal-magnification region 409 in equal magnification (“100%”) in a frame of the back-surface-side image. Here, the method with which the back-surface-image generating unit 205 locates the equal-magnification region 409 is not especially limited. For example, the method with which the equal-magnification region 409 is located in descending order from the upper left portion of the frame of the back-surface-side image can be employed. Then, the back-surface-image generating unit 205 generates the located equal-magnification region 409 as a back-surface-side image 412 of duplex printing. Consequently, the equal-magnification region 409 designated by the user is used as the back-surface-side image 412 in equal magnification. This ensures visibility of the front-surface-side image 411, which is even degraded by the reduction, by confirming the back-surface-side image 412.

Subsequently, when generating the back-surface-side image 412 of duplex printing, the back-surface-image generating unit 205 notifies a number adding unit 206 (which is also referred to as a count adding circuit) of the generation. When the number of the designated equal-magnification region is equal to or more than two (FIG. 3: YES in S109), this notified number adding unit 206 adds a predetermined number at the proximity of the designated front-surface-side equal-magnification region, among the front-surface-side image 411. Additionally, the number adding unit 206 adds a number, which is equal to the number added to this front-surface-side equal-magnification region, at the proximity of the back-surface-side equal-magnification region that corresponds to the front-surface-side equal-magnification region, among the back-surface-side image 412 (FIG. 3: S110).

Here, in the above description, the number of the designated equal-magnification region is one (FIG. 3: NO in S109), and thus the number adding unit 206 returns the number of the designated equal-magnification region to the initial value (“0 times”) without doing anything. Then the number adding unit 206 notifies the back-surface-image generating unit 205 of the initialization. Later, a description will be given of the case where the number of the designated equal-magnification region is equal to or more than two.

The notified back-surface-image generating unit 205 notifies a duplex printing unit 207 (which is also referred to as a duplex printing circuit) of the initialization. This notified duplex printing unit 207 prints the image corresponding to the front-surface-side image 411 on a front surface of a predetermined paper sheet and prints the image corresponding to the back-surface-side image 412 on the back surface of this paper sheet (FIG. 3: S111).

Here, the method with which the duplex printing unit 207 prints is not especially limited. For example, the duplex printing unit 207 conveys a predetermined paper sheet via the conveyance path 103, and performs image formation of the toner image corresponding to the front-surface-side image 411 on this paper sheet, via the image forming unit 104. Next, the duplex printing unit 207 turns over the single-side printed matter, on which the image has been formed, via the duplex printing conveyance path 105. Then the duplex printing unit 207 conveys this turned-over single-side printed matter to the image forming unit 104, and performs image formation of the toner image corresponding to the back-surface-side image 412 on the back surface of the single-side printed matter via this image forming unit 104. Then, the duplex printing unit 207 discharges the duplex printed matter, on which the images have been formed, and terminates the process. The size of the paper sheet is set to A4 size when the multi-functional peripheral 100 is an A4-type image forming apparatus.

As illustrated in FIG. 4B, the front-surface-side image 411, where the A3-size image 410 is reduced to A4 size, is printed on the front surface of this duplex printed matter, and the equal-magnification region 409, which is designated from the A3-size image 410 in equal magnification, is printed on the back surface of this duplex printed matter. When the confirmation of the contents of the designated equal-magnification region among the front-surface-side image 411 is difficult, on the front surface of duplex printed matter, this enables the user to confirm the equal-magnification region 409 by viewing the back surface of this duplex printed matter. Thus, this ensures visibility of the image 410 even when performing reduced printing.

Especially, in reduced printing, this can eliminate a problem that characters of image of a print target are too small for a user to read, or similar problem. Although characters are designated as the equal-magnification region in the above description, designating a region where equal-magnification printing has a meaning, for example, such as a seal field, as an equal-magnification region is effective because a user can press a seal within the seal field.

The designated equal-magnification region is not automatically processed by equal magnification but printed on a back surface by equal magnification. This eliminates damage to the overall composition of the front-surface-side printed matter and can prevent failures such as missing of information due to covering of a front-surface image by an equal-magnification region. Further, such process can be achieved with simple algorithm and thus ensures high cost performance.

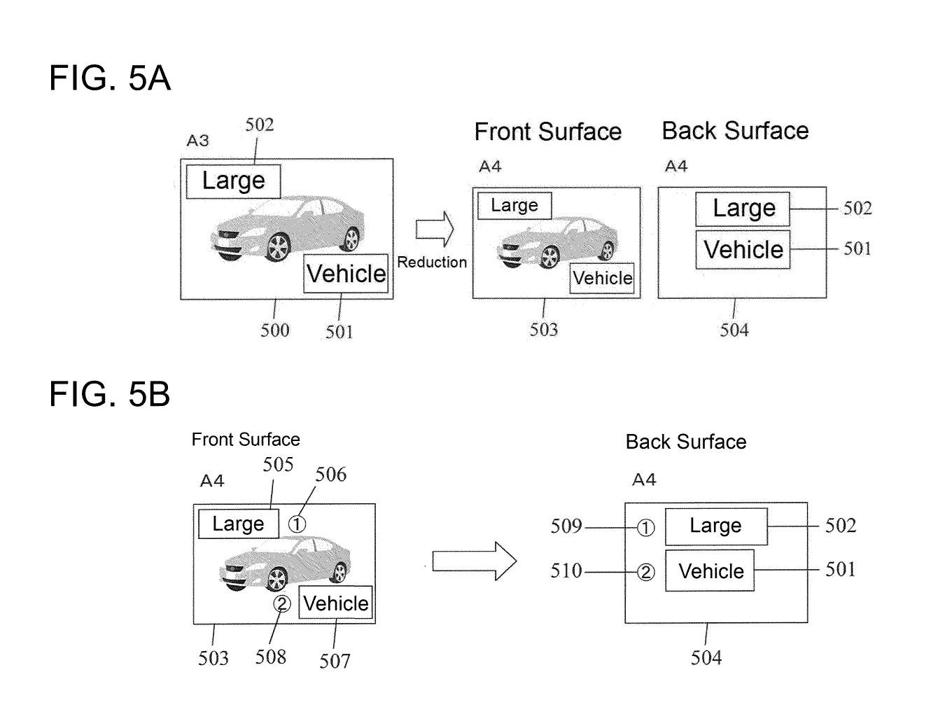

Next, the following describes the case where the number of the designated equal-magnification region is equal to or more than two. That is, for example, as illustrated in FIG. 5A, a user designates two character regions (such as, “vehicle” and “large”) among selected image 500 as equal-magnification regions 501 and 502, respectively. Then, the equal-magnification-region-designation accepting unit 202 accepts the designation of the two equal-magnification regions 501 and 502. Then, the count unit 203 counts the number of these designated equal-magnification regions 501 and 502, every time the equal-magnification regions 501 and 502 are designated by the user. The user can designate a plurality of equal-magnification regions unless the user selects the OK key 405 (FIG. 3: NO in S106). Then, when the user terminates the designation of the equal-magnification region and selects the OK key 405, the equal-magnification-region-designation accepting unit 202 terminates the designation of the equal-magnification region (FIG. 3: YES in S106). Subsequently, the front-surface-image generating unit 204 reduces the image 500 in accordance with the selected reduction magnification (“from A3 to A4”), and generates this reduced image as a front-surface-side image 503 of the duplex printing (FIG. 3: S107). Further, the back-surface-image generating unit 205 obtains the designated equal-magnification region 501 and 502 among the selected image 500, in equal magnification to the magnification of this image 500. Then, the back-surface-image generating unit 205 generates a back-surface-side image 504 of the duplex printing using these obtained equal-magnification regions 501 and 502 in equal magnification (FIG. 3: S108).

In the above description, the number adding unit 206 determines that the number of the equal-magnification regions 501 and 502 is equal to or more than two (FIG. 3: YES in S109), because the number of the equal-magnification regions 501 and 502 is two. Then, the number adding unit 206 adds numbers to the front-surface-side image 503 and the back-surface-side image 504 of the duplex printing, respectively (FIG. 3: S110).

Here, the method with which the number adding unit 206 adds a number is not especially limited. For example, as illustrated in FIG. 5B, the number adding unit 206 first refers to the front-surface-side image 503 and identifies a predetermined equal-magnification region 505 (“large” on the front-surface side), which is present on the upper portion of this front-surface-side image 503. Next, the number adding unit 206 obtains pixel values of pixels at the proximity of this identified front-surface-side equal-magnification region 505, and then searches a region (a minimum edge region) of the pixels, where a difference of pixel values of two adjacent pixels is minimal, based on these obtained pixel values of the pixels. Here, the region of the pixels, where a difference of the pixel values of the two pixels is minimal, can include, for example, a white solid image region, a black solid image region, and similar image region, and is a region that usually does not affect the contents of the front-surface-side image 503. Then, the number adding unit 206 searches the region of the pixels, where a difference of the pixel values of the two pixels is minimal and which has a threshold region to be able to add the numbers. Subsequently, the number adding unit 206 adds a first number 506 (such as “1”) to this searched region of the pixels. This enables to add one number 506 to the one front-surface-side equal-magnification region 505. Further, the number adding unit 206 identifies the next equal-magnification region 507 (“vehicle” on the front-surface side) from the front-surface-side image 503. Then the number adding unit 206 obtains the pixel values of the pixels at the proximity of this identified front-surface-side equal-magnification region 507, and searches the region of the pixels, where the difference of the pixel values of the two adjacent pixels is minimal, based on these obtained pixel values of the pixels. Subsequently, the number adding unit 206 adds the next number 508 (such as “2”) to the searched region of the pixels. Thus, the number adding unit 206 adds numbers indicating the order, as many as the number of the front-surface-side equal-magnification regions 505 and 507, in a predetermined order (such as in descending order), by the respective front-surface-side equal-magnification regions 505 and 507. This ensures identification of the front-surface-side equal-magnification regions 505 and 507 by these numbers.

Next, the number adding unit 206 adds numbers equal to the numbers added to these front-surface-side equal-magnification regions 505 and 507, at the proximity of the back-surface-side equal-magnification regions 501 and 502, which correspond to the front-surface-side equal-magnification regions 505 and 507, among the back-surface-side image 504. Specifically, the number adding unit 206 refers to the predetermined back-surface-side equal-magnification region 502 (“large”) among the back-surface-side image 504, and searches the front-surface-side equal-magnification region 505, which corresponds to the back-surface-side equal-magnification region 502. Then, the number adding unit 206 obtains the number (“1”) added to this searched front-surface-side equal-magnification region 505, and adds a number 509 (“1”) equal to this obtained number (“1”) to the left-side proximity of the back-surface-side equal-magnification region 502. Subsequently, the number adding unit 206 searches the front-surface-side equal-magnification region 507, which corresponds to the next back-surface-side equal-magnification region 501 (“vehicle”). Then, the number adding unit 206 adds a number 510 (“2”) equal to the number (“2”) added to this searched front-surface-side equal-magnification region 507, to the left-side proximity of the back-surface-side equal-magnification region 501. The number adding unit 206 performs such processes as many as the number of the back-surface-side equal-magnification regions 501 and 502. This enables to associate the front-surface-side equal-magnification region 505 with the back-surface-side equal-magnification region 502 and associate the front-surface-side equal-magnification region 507 with the back-surface-side equal-magnification region 501 by numbers. Thus, this enables the reliable confirmation of the contents of the respective equal-magnification regions by the back surface even when a plurality of equal-magnification regions are designated.

After the number adding unit 206 adds numbers, the number of the equal-magnification region returns to the initial value (“0 times”), and the process proceeds to S111. In this case, the duplex printing unit 207 prints on the front surface of the predetermined paper sheet corresponding to the front-surface-side image 503, where the numbers are added, and prints on the back surface of this paper sheet corresponding to the back-surface-side image 504 (FIG. 3: S111).

Although two equal-magnification regions are designated in the above description, the same applies to the case where equal to or more than two equal-magnification regions are designated.

While In the embodiment of the disclosure the multi-functional peripheral 100 is configured to include respective units, it is possible to provide a configuration that causes a recording medium to store programs that achieve these respective units and provide this recording medium. This configuration causes the image forming apparatus to read the programs, and this image forming apparatus achieves the respective units. In this case, the operations and effects of the disclosure can be achieved by the program s themselves read from the recording medium. Furthermore, the embodiment of the disclosure can be provided as a method to cause a hard disk to store steps executed by respective units.

As described above, the image forming apparatus and the image forming method according to the disclosure are effective not only to a multi-functional peripheral but also to a copier and similar device, and also effective as an image forming apparatus and an image forming method that ensure prevention of missing of necessary information, when performing reduced printing of image data.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming apparatus, comprising:
an equal-magnification-region-designation accepting circuit that accepts a reduction magnification of a reduced printing and a designation of an equal-magnification region in the reduced printing that prints a reduced image represented by image data, the equal-magnification region being a target of an equal-magnification printing in the image;
a front-surface-image generating circuit that reduces the image in accordance with the reduction magnification to generate image data representing the reduced image as image data representing a front-surface-side image of duplex printing;
a back-surface-image generating circuit that uses the designated equal-magnification region in the image before the reduction by a magnification equal to the magnification of the image to generate image data representing a back-surface-side image of duplex printing; and
a duplex printing circuit that prints an image corresponding to the front-surface-side image data on a front surface of a predetermined paper sheet and an image corresponding to the back-surface-side image data on the back surface of the paper sheet.

2. The image forming apparatus according to claim 1, further comprising:
a count circuit that counts a count of the designated equal-magnification region in response to the designation of the equal-magnification region; and
a count adding circuit that, when the count of the designated equal-magnification region is equal to or more than two, adds a predetermined count at proximity of the designated front-surface-side equal-magnification region in the front-surface-side image and adds a count at proximity of a back-surface-side equal-magnification region corresponding to the front-surface-side equal-magnification region in the back-surface-side image, the count being equal to the count added to the front-surface-side equal-magnification region.

3. The image forming apparatus according to claim 2, wherein the count adding circuit searches a region of pixels where a difference of pixel values of two adjacent pixels is minimal based on the pixel values of the pixels at proximity of the front-surface-side equal-magnification region, and adds a predetermined count to the searched region of the pixels.

4. An image forming method, comprising:
accepting a reduction magnification of a reduced printing and a designation of an equal-magnification region in the reduced printing that prints a reduced image represented by image data, the equal-magnification region being a target of an equal-magnification printing in the image;
reducing the image in accordance with the reduction magnification to generate image data representing the reduced image as image data representing a front-surface-side image of duplex printing;
using the designated equal-magnification region in the image before the reduction by a magnification equal to the magnification of the image to generate image data representing a back-surface-side image of duplex printing; and
printing an image corresponding to the front-surface-side image data on a front surface of a predetermined paper sheet and an image corresponding to the back-surface-side image data on the back surface of the paper sheet.

5. A non-transitory computer-readable recording medium storing an image forming program to control an image forming apparatus, the image forming program causing the image forming apparatus to function as:
an equal-magnification-region-designation accepting circuit that accepts a reduction magnification of a reduced printing and a designation of an equal-magnification region in the reduced printing that prints a reduced image represented by image data, the equal-magnification region being a target of an equal-magnification printing in the image;
a front-surface-image generating circuit that reduces the image in accordance with the reduction magnification to generate image data representing the reduced image as image data representing a front-surface-side image of duplex printing;
a back-surface-image generating circuit that uses the designated equal-magnification region in the image before the reduction by a magnification equal to the magnification of the image to generate image data representing a back-surface-side image of duplex printing; and
a duplex printing circuit that prints an image corresponding to the front-surface-side image data on a front surface of a predetermined paper sheet and an image corresponding to the back-surface-side image data on the back surface of the paper sheet.
